(19) United States
(12) Patent Application Publication
(10) Pub. No.: US 2025/0199197 A1
(43) Pub. Date: Jun. 19, 2025

(54) SURROGATE MODELING METHOD FOR SHALE OIL FRACTURED SYSTEM SIMULATION BASED ON TRAJECTORY PIECEWISE-LINEARIZATION

(71) Applicant: China University of Petroleum (East China), Qingdao City (CN)

(72) Inventors: Jianchun XU, Qingdao City (CN); Ming GAO, Qingdao City (CN); Wenyue SUN, Qingdao City (CN); Shuyang LIU, Qingdao City (CN); Junrong LIU, Qingdao City (CN); Xiaopu WANG, Qingdao City (CN); Caojie LI, Qingdao City (CN)

(21) Appl. No.: 18/953,209

(22) Filed: Nov. 20, 2024

(30) Foreign Application Priority Data
Dec. 18, 2023 (CN) 202311737644.4

(51) Int. Cl. G01V 20/00; E21B 47/08; G06F 17/11

(52) U.S. Cl. CPC G01V 20/00; E21B 47/08; G06F 17/11; E21B 2200/20

(57) ABSTRACT

Provided is a surrogate modeling method for shale oil fractured system simulation based on trajectory piecewise-linearization, which relates to the technical field of unconventional oil and gas development and includes: establishing a numerical simulation model of a shale oil reservoir fractured system, and solving the numerical simulation model to obtain solution data of a matrix and a fracture of an original model; constructing base functions of matrix and fracture solutions by a sampling matrix; finding a saved solution closest to field data of a current time step in a training trajectory; obtaining a linear equation set for ascertaining field data of next time step, and performing projection and order reducing solving; and verifying whether field data of a new time step is reasonable until a set production time is reached. A resulting surrogate model can rapidly simulate slightly compressible flow in a fractured porous medium.

### CROSS REFERENCE TO RELATED APPLICATION

This patent application claims the benefit and priority of Chinese Patent Application No. 202311737644.4, filed with the China National Intellectual Property Administration on Dec. 18, 2023, the disclosure of which is incorporated by reference herein in its entirety as part of the present application.

### TECHNICAL FIELD

The present disclosure relates to the technical field of unconventional oil and gas development, and in particular, to a surrogate modeling method for shale oil fractured system simulation based on trajectory piecewise-linearization.

### BACKGROUND

Shale oil is a key part in the global energy market, and its development has attracted extensive attention. In this field, the use of a hydraulic fracturing technique is crucial. Effective shale oil reservoir simulation must take into account a reservoir matrix, a natural fracture, and a fracture produced by artificial fracturing. These factors present important challenges in an exploitation process. Therefore, accurate and efficient fracture system simulation is crucial for understanding reservoir characteristics, optimizing an exploitation strategy, and increasing the output and the efficiency of shale oil.

However, in regard to simulation of a fractured system, a balance between computational accuracy and efficiency has always been a problem. A double-medium model and a discrete fracture model that are commonly used at present face challenges in dealing with the complexity and heterogeneity of fracture system. For example, the double-medium model has an advantage in computational efficiency, but the homogeneity assumed by the double-medium model does not conform to the complexity of an actual fractured system. Meanwhile, a traditional shape factor based on steady-state cross flow has been unable to meet the accuracy requirement, and an improvement method such as a non-steady-state cross flow factor needs to be considered. The discrete fracture model is capable of characterizing a fracture form and flow more accurately, but its dependence on a large number of fine unstructured grids leads to a high computational cost, which restricts its extensive use in practical production.

An embedded discrete fracture model (EDFM), as an emerging technique, has been proven to have significant advantages in simulating a complex fractured system, such as a shale oil reservoir. The EDFM is applicable to flow simulation of a plurality of fractured systems, e.g., a projection-based embedded discrete fracture model for low conductivity fractures. In recent years, the EDFM has become a popular option for a shale oil reservoir fracture-matrix coupling method. While the EDFM shows a huge potential in simulating a complex fractured system, it faces a challenge with respect to computational efficiency in practical use. Especially for tasks such as oil reservoir production and history fitting, due to the heterogeneity of the shale oil reservoir per se and the complexity of the fractured system, the EDFM still needs to handle a large-scale matrix solving problem, resulting in problems of high computational cost and low efficiency.

In recent years, in order to overcome these restrictions, researchers and engineers have begun to explore acceleration and surrogation methods of various simulations. These methods are intended to reduce the demand for computing resources while maintaining the simulation accuracy. A popular method is a surrogate model (or a reduced-order model), which may approximate behaviors of a complex system by creating a simplified system representation. The surrogate model is typically based on detailed simulation results of an original system. However, by simplifying and optimizing a computational process, a computation time and resource consumption can be reduced. However, this method has not been used and promoted in the field of fractured system simulation including the EDFM. Therefore, there has been an urgent need to develop a surrogate modeling method specifically for the EDFM in shale oil fractured system simulation.

### SUMMARY

In order to solve the above technical problems, the present disclosure provides a surrogate modeling method for shale oil fractured system simulation based on trajectory piecewise-linearization. On the basis of inheriting the capability of an embedded discrete fracture model (EDFM) to accurately describe a form of a fracture and flow characteristics of a fluid, this method is fused with a simulation surrogating technique based on trajectory piecewise-linearization (TPWL). With the efficient computational capability of the TPWL, the computation speed of EDFM simulation is greatly increased. By applying this method, not only can high-accuracy description of a form and a flow behavior of a shale oil reservoir fracture be maintained, but also a simulation solving speed can be increased by 3 orders of magnitudes. Especially in processing large-scale data and complex computation, the computational efficiency and a response speed can be significantly increased.

A shale oil fractured system simulation surrogating method based on piecewise trajectory linearization specifically includes the following steps:
S1, establishing a numerical simulation model of a shale oil reservoir fractured system according to an establishment method of an embedded discrete fracture model based on a condition of a shale oil reservoir, and by fully implicit discretization, solving a nonlinear system at each time step using Newton iteration method;
S2, running an original model for one or more high-fidelity original simulations as a training process to obtain solution data of a matrix and a fracture of the original model, and saving gradient information of iteration convergence at each time step;
S3, performing singular value decomposition (SVD) on a sampling matrix to obtain a base function, namely a proper orthogonal decomposition (POD) function, and separately constructing and saving base functions of matrix and fracture solutions;
S4, updating the solution data to a current known time step, setting a well control parameter to be used in surrogate simulation, and finding a saved solution closest to field data of the current time step in a training trajectory;
S5, based on a piecewise linearization principle, spreading a point with the saved gradient information and information of a solution of the point to obtain a linear equation set for ascertaining field data of next time step, and performing projection and order reducing solving; and
S6, verifying whether field data of a new time step is reasonable; if “no”, returning to S4; if “yes”, reconstructing and updating the field data, and progressing to next time step until a production time is reached and outputting a result.

Further, step S1 may specifically include:
determining a scale and a shape of the shale oil reservoir, and identifying and quantifying a form and distribution characteristics of fractures in detail;
computing a conductivity coefficient between a fracture cell and an adjacent matrix, and a conductivity coefficient of a single fracture between two matrix grids and a conductivity coefficient between two cross fracture cells, where this process involves three different seepage modes, as shown in FIG. 1; and
after the completion of computing the conductivity coefficients, establishing a numerical simulation model of a fractured system using numerical simulation software for oil reservoirs or Matlab software, and performing fully implicit discretization on the numerical simulation model to obtain a discretized form of the fractured system.

Further, taking a single-phase system as an example, the fractured system may be expressed as:

$$∇ \cdot {( \frac{k}{B μ} ∇ p )}_{m} + {[ \frac{\partial }{\partial t} ( \frac{φ}{B} ) ]}_{m} + {q}_{m} + {q}_{m - f} = 0 on {Ω}_{m} ⊂ {R}^{n}$$

$$∇ \cdot {( \frac{k}{B μ} ∇ p )}_{f} + {[ \frac{\partial }{\partial t} ( \frac{φ}{B} ) ]}_{f} + {q}_{f} + {q}_{m - f} = 0 on {Ω}_{f} ⊂ {R}^{n - 1} ;$$

where m represents the matrix; f represents the fracture; and k, B, μ, and φ represent a permeability, a volume coefficient, a fluid viscosity, and a porosity, respectively, where

$$∇ \cdot ( \frac{k}{B μ} ∇ p )$$

is a flow term,

$$[ \frac{\partial }{\partial t} ( \frac{φ}{B} ) ]$$

is a cumulative term, and q is a source sink term.

The above formula may be simplified as:

$$g ( {x}^{n + 1} , {x}^{n} , {u}^{n + 1} ) = F ( {x}^{n + 1} ) + A ( {x}^{n + 1} , {x}^{n} ) + Q ( {x}^{n + 1} , {u}^{n + 1} ) = 0 ;$$

where g represents a fractured system flow model derived from a mass conservation equation in combination with Darcy's law; x represents a solution of the system, such as a saturation and a pressure, which is the pressure in the single-phase system; u represents a well control parameter of the system, which is a known value and usually occurs in the source sink term; n and n+1 represent a current time step and next time step; and F, A, and Q are the flow term, the cumulative term, and the source sink term, respectively, which can be calculated with various conductivity coefficients according to Darcy's seepage law.

Further, in step S1, a computational formula for the conductivity coefficient between the fracture cell and its adjacent matrix is as follows:

$${T}_{m - f} = \frac{{A}^{nnc} {k}^{nnc}}{{d}^{nnc}} ;$$

where T_{m-f} represents a conductivity coefficient between a matrix grid and the fracture cell; A^{nnc} represents a surface area of a fracture in the matrix grid; k^{nnc} represents a harmonic mean value of permeabilities of the matrix grid and the fracture cell; and d^{nnc} represents an average normal distance between the matrix grid and the fracture cell therein, which is determined by the following computational formula:

$${d}^{nnc} = \frac{{\int }_{V} {x}_{n} dv}{V} ;$$

where dv represents a volume element; xₙ represents a normal distance from a volume element of the matrix to the fracture cell; and V represents a volume of the matrix grid. For the conductivity coefficient of a single fracture between two matrix grids, A^{nnc} represents a contact area of the fracture cells; k^{nnc} represents the harmonic mean value of permeability of two fracture cells; and d^{nnc} represents the distance between centers of two fracture cells.

For two cross fracture cells, a computational formula for the conductivity coefficient may be as follows:

$${T}_{f 1 - f 2} = \frac{{T}_{f 1} {T}_{f 2}}{{T}_{f 1} + {T}_{f 2}}$$

$${T}_{f 1} = \frac{{k}_{f 1} {ω}_{f 1} {L}_{int}}{{d}_{f 1}}$$

$${T}_{f 2} = \frac{{k}_{f 2} {ω}_{f 2} {L}_{int}}{{d}_{f 2}} ;$$

where T_{f1-f2} represents the conductivity coefficient between the cross fracture cells; T_{f1} and T_{f2} represent respective conductivity coefficients of the two fracture cells; k_{f} and ω_{f} represent the permeability and a fracture width of the fracture cell, respectively; Lᵢₙₜ represents a length of a cross segment of the fracture cells; and d_{f} represents an average normal distance of centers of fracture segments on two sides of an intersecting line of fractures to the intersecting line.

Further, in step S2, a well control parameter for training simulation may need to be preset for running of a high-fidelity original model; the well control parameter for two training simulations may include: a constant value and a randomly varying value within certain upper and lower limits. Under the preset well control condition, pressure field and saturation field data of every time steps are saved; a plurality of training simulations are performed or a long training simulation termination time is set to capture comprehensive field evolution behaviors, and the snapshot matrices are obtained as follows:

$${X}_{m} = [ \begin{matrix}{X}_{m}^{1} & {X}_{m}^{2} & … & {X}_{m}^{s}\end{matrix} ]$$

$${X}_{f} = [ \begin{matrix}{X}_{f}^{1} & {X}_{f}^{2} & … & {X}_{f}^{s}\end{matrix} ] ;$$

where Xₘ and X_{f} represent a snapshot matrix of matrix and fracture, respectively; m represents the matrix; f represents the fracture; Xₘⁱ and X_{f}ⁱ represent sampled snapshot saved at each time step, 1, 2, . . . , s representing sampling numbers; and each snapshot is a vector composed of solution data of the pressure and the saturation of each grid/cell.

Further, in step S3, performing singular value decomposition on a sampling matrix to obtain a base function, namely a POD function, include:

Xₘ=UₘSₘVₘ^{T}

X_{f}=U_{f}S_{f}V_{f}^{T};
where U represents a matrix containing a singular vector; S represents a corresponding singular value matrix; all other elements than those in a principal diagonal are 0, and each element in the principal diagonal is called a corresponding singular value of each singular vector in U; and V represents other unitary matrix than U, which satisfies: V^{T}V=I;
analyzing an energy contribution or an accumulative energy contribution of the base function to determine a number of final base functionals, where a computational formula for the accumulative energy contribution is as follows:

$${E}_{{k}_{m}} = \frac{{{\sum }_{i = l}}^{k} {σ}_{m , i}^{2}}{{{\sum }_{i = l}}^{s} {σ}_{m , i}^{2}}$$

$${E}_{{k}_{f}} = \frac{{{\sum }_{i = l}}^{k} {σ}_{f , i}^{2}}{{{\sum }_{i = l}}^{s} {σ}_{f , i}^{2}} ;$$

where Eₖ_{ₘ} and Eₖ_{_{f}} represent accumulative energy contributions of first k base functions corresponding to the matrix and the fracture, respectively; and σ_{m,i} and σ_{f,i} represent singular values corresponding to i-th singular vectors of the matrix and the fracture, respectively; and
obtaining a desired number of base functions by limiting the accumulative energy contribution to be more than 0.95 to 0.99, thereby finally obtaining a base function matrix as follows:

$$Φ = ( \begin{matrix}{Φ}_{m} & 0 \\ 0 & {Φ}_{f}\end{matrix} ) ;$$

where Φ represents a total matrix composed of the base functions; and Φₘ and Φ_{f} represent submatrices composed of the base functions for the matrix and the fracture, respectively, with other positions all being 0.

Further, in step S4, projection and order reducing may be performed on a solution of the current time step by:

Φ^{T}xⁿ≈zⁿ;
where zⁿ represents a linear combination coefficient corresponding to the base function of the current time step, namely an order reduced solution.

In order to find the closest saved solution, a closest order reduced solution zⁱ may be directly found, which may be directly ascertained by traversal according to:

$${min}_{t} \vert {z}^{n} - {z}^{i} \vert .$$

Further, in step S5, after the closest order reduced solution zⁱ is determined, the following equation set may be established:

$${Φ}^{T} {J}^{i + 1} Φ ( {z}^{n + 1} - {z}^{i + 1} ) = - {Φ}^{T} [ {A}^{i + 1} Φ ( {z}^{n} - {z}^{i} ) + {Q}^{i + 1} ( {u}^{n + 1} - {u}^{i + 1} ) ] ;$$

where

$${J}^{i + 1} = \frac{\partial {g}^{i + 1}}{\partial {x}^{i + 1}} , {A}^{i + 1} = \frac{\partial {g}^{i + 1}}{\partial {x}^{i}} , and {Q}^{i + 1} = \frac{\partial {g}^{i + 1}}{\partial {u}^{i + 1}} .$$

The data has been saved in the gradient information saved in a training simulation process. By order reduction, the process of ascertaining zⁿ⁺¹ is a low-order linear equation, and a number of dimensions is equal to a number of selected base functions and is far less than that of linear equation sets needing to be solved by an original full-order model.

Further, in step S6, whether an obtained solution is reasonable may be verified by traversal computation according to:

$${min}_{j} \vert {z}^{n + 1} - {z}^{j + 1} \vert ;$$

when j≠i, the solution is unreasonable, the point is ruled out and the closest point is reselected for spreading; and
when j=i, the solution is reasonable, reconstruction is performed by the following formula while progressing to next time step until a specified production time is reached:

xⁿ⁺¹=Φzⁿ⁺¹.

The present disclosure has the following beneficial effects:
(1) The present disclosure defines a shale oil fractured system simulation surrogating method based on piecewise trajectory linearization. A resulting surrogate model can rapidly simulate slightly compressible flow in a fractured porous medium. In combination with an order reducing method, a nonlinear iteration problem is transformed into a linear spreading problem of a point. A numerical solving technique having higher computational efficiency and sufficient accuracy is constructed.
(2) The present disclosure shows higher computational efficiency and can be applied to processes requiring computation costs, such as sensitivity analysis, history matching, and oilfield development strategy optimization. The surrogate model can be proven to be application to the fields of heterogeneous, anisotropic fractured systems having complex fracture networks and numerous wells.

The present disclosure may be regarded as a universal simulation surrogating method for studying underground fluid transport in a reservoir of a shale oil fractured system.

### BRIEF DESCRIPTION OF THE DRAWINGS

FIG. 1 is a schematic diagram illustrating three different seepage modes of an EDFM according to the present disclosure;

FIG. 2 is a schematic diagram illustrating a technical route of operations according to the present disclosure;

FIG. 3 is a schematic diagram of a well control setting used for testing a surrogate model in Example 1;

FIG. 4 is a schematic diagram illustrating a relative error distribution of solutions of an original model and a surrogate model in Example 1;

FIG. 5 is a planar schematic diagram of a geologic model in Example 2;

FIG. 6 a schematic diagram of a well control setting used for testing a surrogate model in Example 2; and

FIG. 7 is a schematic diagram illustrating a pressure error frequency distribution in Example 2.

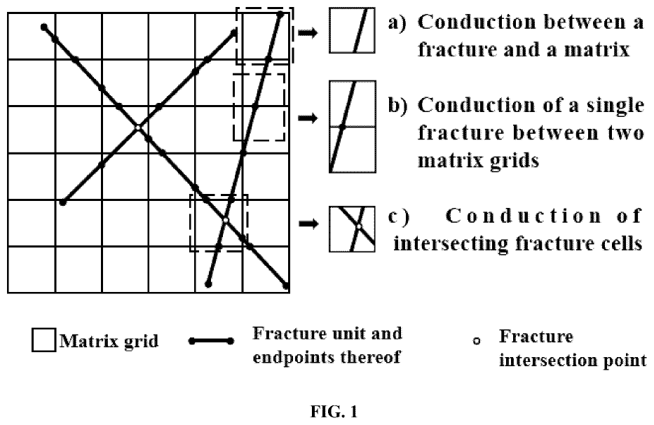

### DETAILED DESCRIPTION OF THE EMBODIMENTS

In order to make the objective, technical solutions, and advantages of the embodiments of the present disclosure clearer, the technical solutions in the embodiments of the present disclosure will be clearly and completely described below in conjunction with the accompanying drawings in the embodiments of the present disclosure. Apparently, the described embodiments are some, rather than all of the embodiments of the present disclosure. On the basis of the embodiments of the present invention, all other embodiments obtained by a person of ordinary skill in the art without making creative efforts shall fall within the scope of protection of the present disclosure.

### Example 1

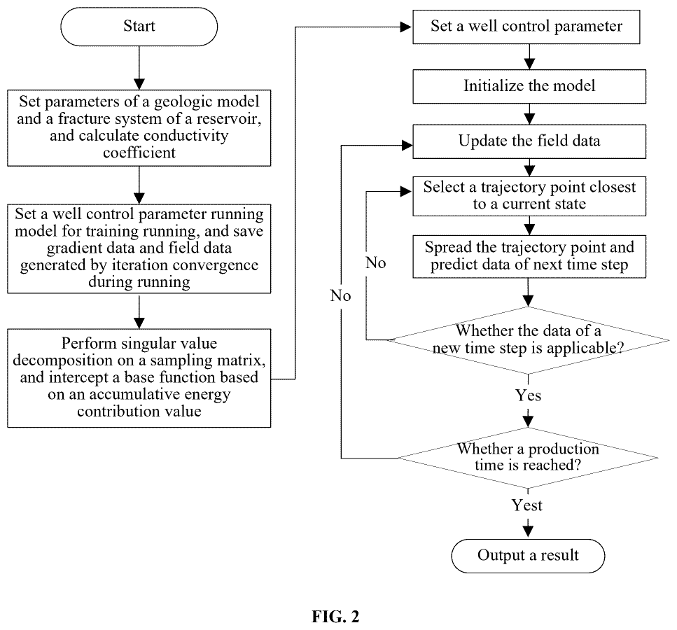

A shale oil fractured system simulation surrogating method based on piecewise trajectory linearization, as shown in FIG. 2, includes the following steps.

In step S1, distribution position, form, and length parameters of a fracture in a fractured reservoir are obtained from in-situ data to determine a fracture development degree in an oil reservoir, and seepage flows between a matrix and a fracture, between fractures, and between fracture cells are taken into account. Conductivity coefficients in three seepage processes are calculated. A numerical simulation model of a fractured system of an EDFM is established, in which 6 cross fractures have developed. A maximum time step length for running each time is 20 days. Basic model parameters are as shown in the following Table 1.

TABLE 1

| Parameter | Value | Unit |
|---|---|---|
| Formation Thickness | 10 | m |
| Initial Pressure | 20 | MPa |
| Matrix Porosity | 0.1 | |
| Fracture Porosity | 1 | |
| Compressibility of Rock | 0.00086 | 1/MPa |
| Reference Pressure of Rock | 20 | MPa |
| Reference Density of Crude Oil | 1000 | kg/m³ |
| Fracture Width | 1.00E−04 | m |
| Matrix Permeability | 1.00E−16 | m² |
| Fracture Permeability | 8.33E−10 | m² |
| Bottom Hole Pressure | 13-20 | MPa |
| Model Simulation Time | 1000 | day |

In step S2, an original model is run for two high-fidelity simulations to obtain pressure field data of a matrix and a fracture of the original model, and a sampling matrix is obtained.

Here, training simulation is performed in the following manner: for one simulation, production is carried out under constant 16 MPa. For the other simulation, production is carried out such that the bottom hole pressure randomly varies within a range of 14 MPa to 18 MPa every 100 days, for a total 2000 days. Moreover, the pressure field data of the matrix and the fracture at each time step are saved in the training process, and gradient information of iteration convergence at each time step is saved.

In step S3, singular value decomposition (SVD) is performed on the sampling matrix to obtain a base function, namely a proper orthogonal decomposition (POD) function, and base functions of matrix and fracture solutions are separately constructed and saved.

In step S4, the data is updated to a current known time step; a well control parameter to be used in surrogate simulation is set; and a saved solution closest to field data of the current time step in a training trajectory is found.

In step S5, based on a piecewise linearization principle, a point is spread with the saved gradient information and information of a solution of the point to obtain a linear equation set for ascertaining field data of next time step, and projection and order reducing solving are performed.

In step S6, whether field data of a new time step is reasonable is verified; if “no”, the method returns to S4; if “yes”, the field data is reconstructed and updated, and the method progresses to next time step until a production time is reached, and a result is output.

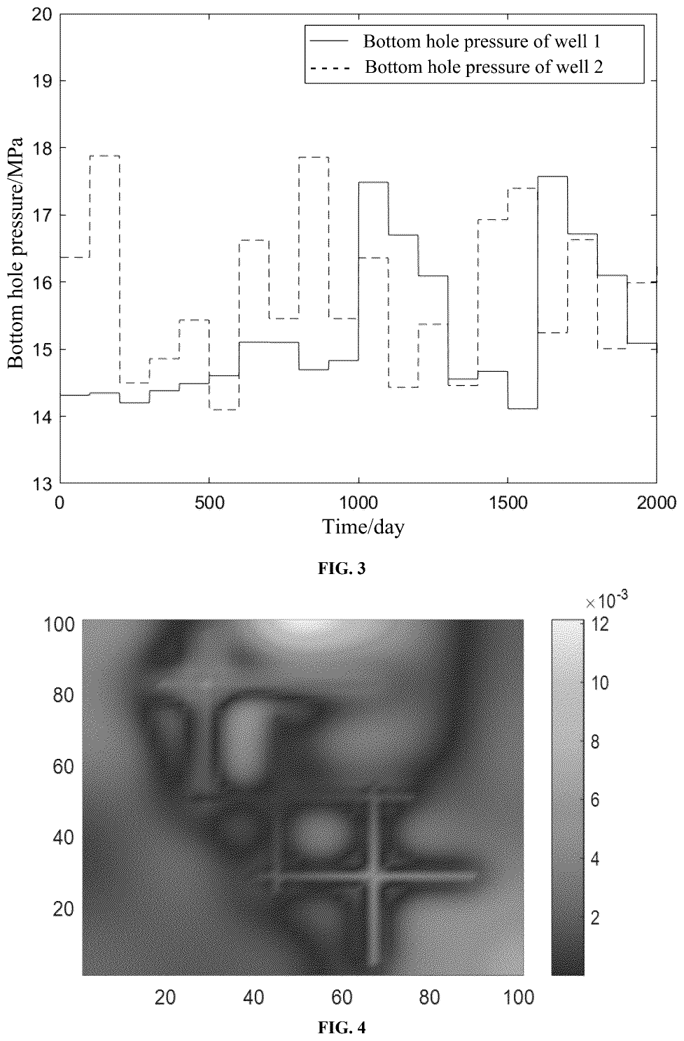

Finally, in this example, a random well control parameter completely different from the training setting is used for training. The robustness of the model after order reduction is verified by selecting variation ranges with different upper and lower limits. As shown in FIG. 3, the well control setting used for testing the surrogate model is expanded to a range of 14 MPa to 18 MPa.

Relative errors of solutions of each grid surrogate simulation and original simulation are compared. As shown in FIG. 4, it can be seen that the maximum relative error is lower than 0.13%. The result is highly consistent, and the computation speed is increased by about 100 times.

### Example 2

A shale oil fractured system simulation surrogating method based on piecewise trajectory linearization includes the following steps.

In step S1, distribution position, form, and length parameters of a fracture in a fractured reservoir are obtained from in-situ data to determine a fracture development degree in a fractured oil reservoir, and seepage flows between a matrix and a fracture, between fractures, and between fracture cells are taken into account. Conductivity coefficients in three seepage processes are calculated. A numerical simulation model of a fractured system of an EDFM is established.

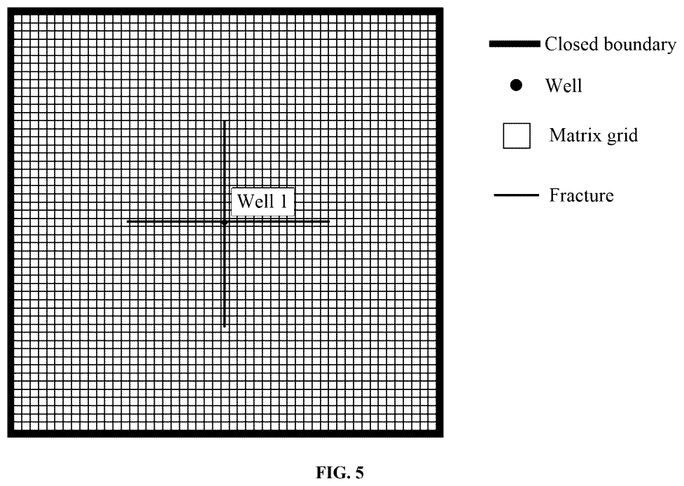

A three-dimensional geologic model is divided into a total of 5 layers of grids, each layer having 51×51 grids, and a total of 13005 matrix grids are obtained. A vertical well is disposed at the center; 2 cross fractures are obtained by fracturing, and a total of 100 fracture cells are obtained, as shown in FIG. 5.

A maximum time step length for running each time is 20 days. A length of the grid in all directions is 2 meters. A reservoir thickness is 10 meters, and there are a total of 5 layers. Other basic model parameters are the same as those in Example 1.

In step S2, an original model is run for one or more high-fidelity original simulations as a training process to obtain solution data of a matrix and a fracture of the original model, and gradient information of iteration convergence at each time step is saved.

In step S3, singular value decomposition (SVD) is performed on the sampling matrix to obtain a base function, namely a proper orthogonal decomposition (POD) function, and base functions of matrix and fracture solutions are separately constructed and saved.

In step S4, the data is updated to a current known time step; a well control parameter to be used in surrogate simulation is set; and a saved solution closest to field data of the current time step in a training trajectory is found.

In step S5, based on a piecewise linearization principle, a point is spread with the saved gradient information and information of a solution of the point to obtain a linear equation set for ascertaining field data of next time step, and projection and order reducing solving are performed.

In step S6, whether field data of a new time step is reasonable is verified; if “no”, the method returns to S4; if “yes”, the field data is reconstructed and updated, and the method progresses to next time step until a production time is reached, and a result is output.

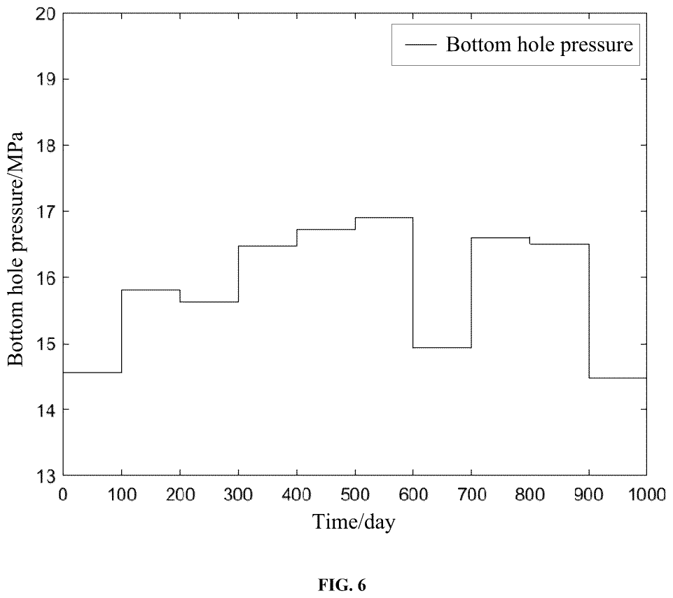

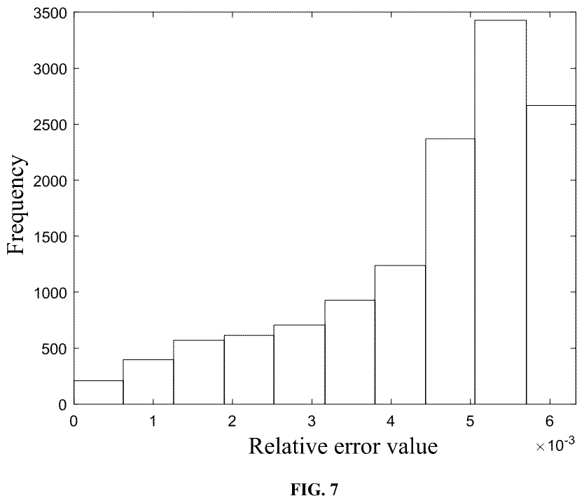

Finally, a well control parameter completely different from the training setting is obtained from a random number for training. A bottom hole pressure setting is as shown in FIG. 6, and a schematic diagram of a relative error frequency distribution of pressure is as shown in FIG. 7. A maximum relative error of the pressure distribution is not more than 0.6%. As can be seen, the three-dimensional model is within a large well control variation range. The model obtained by the surrogating method of the present disclosure has high accuracy and strong robustness, and with increasing number of grids, the surrogating method may achieve more significant acceleration effect. In this example, the running time of the surrogate model is reduced by about 220 times as compared to the original model.

On the basis of inheriting the capability of an embedded discrete fracture model (EDFM) to accurately describe a form of a fracture and flow characteristics of a fluid, the present disclosure is fused with a simulation surrogating technique based on trajectory piecewise-linearization (TPWL). With the efficient computational capability of the TPWL, the computation speed of EDFM simulation is greatly increased.

By applying this method, while high-accuracy description of the form and the flow behaviors of the fracture in the shale oil reservoir is maintained, and the simulation speed can also be increased by about 3 orders of magnitudes. Especially in processing large-scale data and complex computation, the computational efficiency and a response speed can be significantly increased. This method is of important practical significance for the development and production optimization of the shale oil reservoir, history data fitting, and other key operations.

It should be noted that the above description is not intended to limit the present disclosure, and the present disclosure is not limited to the above examples. Changes, modifications, additions or replacements made by those of ordinary skill in the art within the essential range of the present disclosure should fall within the protection scope of the present disclosure.

What is claimed is:

1. A surrogate modeling method for shale oil fractured system simulation based on trajectory piecewise-linearization, specifically comprising the following steps:
S1, establishing a numerical simulation model of a shale oil reservoir fractured system according to an establishment method of an embedded discrete fracture model based on a condition of a shale oil reservoir, and by fully implicit discretization, solving a nonlinear system at each time step using Newton iteration method;
S2, running an original model for one or more high-fidelity original simulations as a training process to obtain solution data of a matrix and a fracture of the original model, and saving gradient information of iteration convergence at each time step;
S3, performing singular value decomposition on a sampling matrix to obtain a base function, namely a proper orthogonal decomposition (POD) function, and separately constructing and saving base functions of matrix and fracture solutions;
S4, updating the solution data to a current known time step, setting a well control parameter to be used in surrogate simulation, and finding a saved solution closest to field data of the current time step in a training trajectory;
S5, based on a piecewise linearization principle, spreading a point with the saved gradient information and information of a solution of the point to obtain a linear equation set for ascertaining field data of next time step, and performing projection and order reducing solving; and
S6, verifying whether field data of a new time step is reasonable; if “no”, returning to S4; if “yes”, reconstructing and updating the field data, and progressing to next time step until a production time is reached and outputting a result;
wherein step S1 specifically comprises:
determining a scale and a shape of the shale oil reservoir, and identifying and quantifying a form and distribution characteristics of fractures in detail;
computing a conductivity coefficient between a fracture cell and an adjacent matrix, and a conductivity coefficient of a single fracture between two matrix grids and a conductivity coefficient between two cross fracture cells; and
after the completion of computing the conductivity coefficients, establishing a numerical simulation model of a fractured system using numerical simulation software, and performing fully implicit discretization on the numerical simulation model to obtain a discretized form of the fractured system;
wherein the fractured system is expressed as:
$$g ( {x}^{n + 1} , {x}^{n} , {u}^{n + 1} ) = F ( {x}^{n + 1} ) + A ( {x}^{n + 1} , {x}^{n} ) + Q ( {x}^{n + 1} , {u}^{n + 1} ) = 0 ;$$
wherein 8 represents a fractured system flow model; X represents a solution of the system; u represents a well control parameter of the system; n and n+1 represent a current time step and next time step; and F, A, and Q are a flow term, a cumulative term, and a source sink term, respectively.

2. The surrogate modeling method for shale oil fractured system simulation based on trajectory piecewise-linearization according to claim 1, wherein in step S1, a computational formula for the conductivity coefficient between the fracture cell and the adjacent matrix is as follows:
$${T}_{m - f} = \frac{{A}^{n n c} {k}^{n n c}}{{d}^{n n c}} ;$$
wherein T_{m-f} represents a conductivity coefficient between a matrix grid and the fracture cell; A^{nnc} represents a surface area of a fracture in the matrix grid; k^{nnc} represents a harmonic mean value of permeabilities of the matrix grid and the fracture cell; and d^{nnc} represents an average normal distance between the matrix grid and the fracture cell therein, which is determined by the following computational formula:
$${d}^{n n c} = \frac{{\int }_{V} {x}_{n} d v}{V} ;$$
wherein dv represents a volume element; xₙ represents a normal distance from a volume element of the matrix to the fracture cell; V represents a volume of the matrix grid; for the conductivity coefficient of a single fracture between two matrix grids, A^{nnc} represents a contact area of the fracture cell; k^{nnc} represents the permeability of the fracture cell; and d^{nnc} represents a distance between centers of two fracture cells; and
for two cross fracture cells, a computational formula for the conductivity coefficient is as follows:
$${T}_{f 1 - f 2} = \frac{{T}_{f 1} {T}_{f 2}}{{T}_{f 1} + {T}_{f 2}}$$
$${T}_{f 1} = \frac{{k}_{f 1} {ω}_{f 1} {L}_{int}}{{d}_{f 1}}$$
$${T}_{f 2} = \frac{{k}_{f 2} {ω}_{f 2} {L}_{int}}{{d}_{f 2}} ;$$
wherein T_{f1-f2} represents the conductivity coefficient between the cross fracture cells; T_{f1} and T_{f2} represent respective conductivity coefficients of the two fracture cells; k_{f} and ω_{f} represent the permeability and a fracture width of the fracture cell, respectively; Lᵢₙₜ represents a length of a cross segment of the fracture cells; and d_{f} represents an average normal distance of centers of fracture segments on two sides of an intersecting line of fractures to the intersecting line.

3. The surrogate modeling method for shale oil fractured system simulation based on trajectory piecewise-linearization according to claim 2, wherein in step S2, a well control parameter for training simulation needs to be preset for running of a high-fidelity original model; the well control parameter for two simulations comprises: a constant value and a randomly varying value within certain upper and lower limits; under the well control condition, pressure field and saturation field data of time steps are run and saved; a plurality of simulations are performed or a long simulation termination time is set to capture comprehensive field evolution behaviors, and a snapshot matrix is obtained as follows:
$${X}_{m} = [ \begin{matrix}{X}_{m}^{1} & {X}_{m}^{2} & … & {X}_{m}^{s}\end{matrix} ]$$
$${X}_{f} = [ \begin{matrix}{X}_{f}^{1} & {X}_{f}^{2} & … & {X}_{f}^{s}\end{matrix} ] ;$$
wherein Xₘ and X_{f} represent a total snapshot matrix; m represents the matrix; f represents the fracture; Xₘⁱ and X_{f}ⁱ represent snapshot saved at each time step, 1, 2, . . . , s representing sampling numbers; and each snapshot is a vector composed of solution data of a pressure and a saturation of each grid/cell.

4. The surrogate modeling method for shale oil fractured system simulation based on trajectory piecewise-linearization according to claim 3, wherein in step S3, the performing singular value decomposition on a sampling matrix to obtain a base function, namely a POD function, comprises:
Xₘ=UₘSₘVₘ^{T}
X_{f}=U_{f}S_{f}V_{f}^{T};
wherein U represents a matrix containing a singular vector; S represents a corresponding singular value matrix; and V represents other unitary matrix than U, which satisfies: V^{T}V=I;
analyzing an energy contribution or an accumulative energy contribution of the base function to determine a number of final base functionals, wherein a computational formula for the accumulative energy contribution is as follows:
$${E}_{{k}_{m}} = \frac{{{\sum }_{i = 1}}^{k} {σ}_{m , i}^{2}}{{{\sum }_{i = 1}}^{s} {σ}_{m , i}^{2}}$$
$${E}_{{k}_{f}} = \frac{{{\sum }_{i = 1}}^{k} {σ}_{f , i}^{2}}{{{\sum }_{i = 1}}^{s} {σ}_{f , i}^{2}} ;$$
wherein Eₖ_{ₘ} and Eₖ_{_{f}} represent accumulative energy contributions of first k base functions corresponding to the matrix and the fracture, respectively; and σ_{m,i} and σ_{f,i} represent singular values corresponding to i-th singular vectors of the matrix and the fracture, respectively; and
obtaining a desired number of base functions by limiting the accumulative energy contribution to be more than 0.95 to 0.99, thereby finally obtaining a base function matrix as follows:
$$Φ = ( \begin{matrix}{Φ}_{m} & 0 \\ 0 & {Φ}_{f}\end{matrix} ) ;$$
wherein Φ represents a total matrix composed of the base functions; and Φₘ and Φ_{f} represent submatrices composed of the base functions for the matrix and the fracture, respectively, with other positions all being 0.

5. The surrogate modeling method for shale oil fractured system simulation based on trajectory piecewise-linearization according to claim 4, wherein in step S4, projection and order reducing are performed on a solution of the current time step by:
Φ^{T}xⁿ≈zⁿ;
wherein zⁿ represents a linear combination coefficient corresponding to the base function of the current time step, namely an order reduced solution;
in order to find the closest saved solution, a closest order reduced solution zⁱ is directly found, which is directly ascertained by traversal according to:
$${min}_{t} \vert {z}^{n} - {z}^{i} \vert .$$

6. The surrogate modeling method for shale oil fractured system simulation based on trajectory piecewise-linearization according to claim 5, wherein in step S5, after the closest order reduced solution zⁱ is determined, the following equation set is established:
$${Φ}^{T} {J}^{i + 1} Φ ( {z}^{n + 1} - {z}^{i + 1} ) = - {Φ}^{T} [ {A}^{i + 1} Φ ( {z}^{n} - {z}^{i} ) + {Q}^{i + 1} ( {u}^{n + 1} - {u}^{i + 1} ) ] ;$$
wherein
$${J}^{i + 1} = \frac{\partial {g}^{i + 1}}{\partial {x}^{i + 1}} , {A}^{i + 1} = \frac{\partial {g}^{i + 1}}{\partial {x}^{i}} , and {Q}^{i + 1} = \frac{\partial {g}^{i + 1}}{\partial {u}^{i + 1}} .$$

7. The surrogate modeling method for shale oil fractured system simulation based on trajectory piecewise-linearization according to claim 6, wherein in step S6, whether an obtained solution is reasonable is verified by traversal computation according to:
$${min}_{j} \vert {z}^{n + 1} - {z}^{j + 1} \vert ;$$
when j≠i, the solution is unreasonable, the point is ruled out and the closest point is reselected for spreading; and
when j=i, the solution is reasonable, reconstruction is performed by the following formula while progressing to next time step until a specified production time is reached: xⁿ⁺¹=Φzⁿ⁺¹.
